(19) United States
(12) Patent Application Publication
(10) Pub. No.: US 2004/0183270 A1
(43) Pub. Date: Sep. 23, 2004

(54) Truck corner module

(76) Inventors: Jesko-Henning Tanke, Schweinfurt (DE); Rico Dittmar, Schmalhalden (DE); Hendrikus Jan Kapaan, Nieuwegein (NL); Norbert Huhn, Schweinfurt (DE); Sven Gothberg, Frolunda (SE)

Correspondence Address: OLIFF & BERRIDGE, PLC, P.O. BOX 19928, ALEXANDRIA, VA, 22320, US

(21) Appl. No.: 10/479,232

(22) PCT Filed: May 29, 2002
(86) PCT No.: PCT/NL02/00341

(30) Foreign Application Priority Data
May 31, 2001 (NL) 1018191

(51) Int. Cl. B60G 1/00

(52) U.S. Cl. 280/93.512

(57) ABSTRACT

A truck corner module comprises a wheel carrying unit (1) provided with an axle stub (3) and a kingpin arrangement (4), and is characterized by an auxiliary unit (2) mounted onto the wheel carrying unit (1), said auxiliary unit (2) being provided with at least parts (29) for a brake means. The axle stub (3) is integrally formed with the kingpin arrangement (4).

The invention is related to the field of steerable wheel suspensions for trucks, also referred to as truck corners. A truck corner usually comprises a kingpin arrangement and a wheel bearing. The kingpin arrangement provides the possibility to carry out steering movements. An example of truck corner module is disclosed in U.S. Pat. No. 5,413,365.

Prior art truck corners have a specific layout with a relatively complicated construction. The object of the invention is to simplify the steerable wheel truck corner. This object is achieved by a truck corner module, which is characterized by provided an auxiliary unit mounted onto the wheel carrying unit, said auxiliary unit having at least fixation means for a brake and/or a steering device.

According to the invention, a complete module is provided which can be mounted as a unity onto the truck wheel suspension. This module is equipped with the basic elements which make up the truck corner, and can be completed by simply adding the components which are required for specific applications. Moreover, the module basically consists of two separate prefabricated units, i.e. the wheel carrying unit and an auxiliary unit, which further adds to the simplicity of the design.

Said units may be carried out in several ways. For instance, the axle stub for the wheel bearing support can be integrally formed with the kingpin arrangement. Alternatively however, the axle stub and the kingpin arrangement could be connected to each other through mounting means.

In the latter case, the mounting means may comprise screw threaded portions; also, the mounting means may comprise cylindrical or conically shaped portions with threaded end or bolt connections. In a preferred embodiment, the axle stub comprises a conically shaped end at the narrow end of which a screw portion is provided, and the kingpin arrangement comprises a correspondingly conically shaped base at the inner end of which a corresponding nut portion is provided. The conically shaped end can also consist of a slitted tapered sleeve, threaded onto a cylindrical stub axle end. A cylindrical centering means can also be considered.

The axle stub for e.g. a truck or trailer may be either solid or hollow with mechanical means at both ends to connect the rotating end or the non-rotating end for structural driven or non-driven purposes. Having regard to the envisaged application in a truck corner with e.g. a rotating wheel bearing outer ring, said axle stub can comprise two mutually spaced raceways for a wheel bearing means. Preferably, said wheel bearing means comprises two tapered bearings, and the raceways of the axle stub are arranged symmetrical with respect to a plane perpendicular to the axle stub axis.

Furthermore, the wheel canying unit may comprise a mounting part, and the auxiliary unit comprises a mounting hole mounted onto the mounting part, in such a way that the axle stub projects at one side of the auxiliary unit, and the kingpin arrangement at the other side of the auxiliary unit. A compact, stiff and light construction is obtained by bolting the wheel carrying unit and the axle unit together.

The auxiliary unit may comprise two fixation ears for a brake, said fixation ears and bolt holes being positioned on opposite sides of a plane defined by the axle stub axis. Preferably, the wheel carrying unit comprises a base member which carries the support bearings for accommodating the kingpin. The kingpin top and bottom bearing support can consist of a roller, ball, self adjusting or plain bearing or a combination of these. The base member carries the axle stub, said axle stub facing away from the support rings.

The invention will now be described further with reference to an embodiment shown in the drawings.

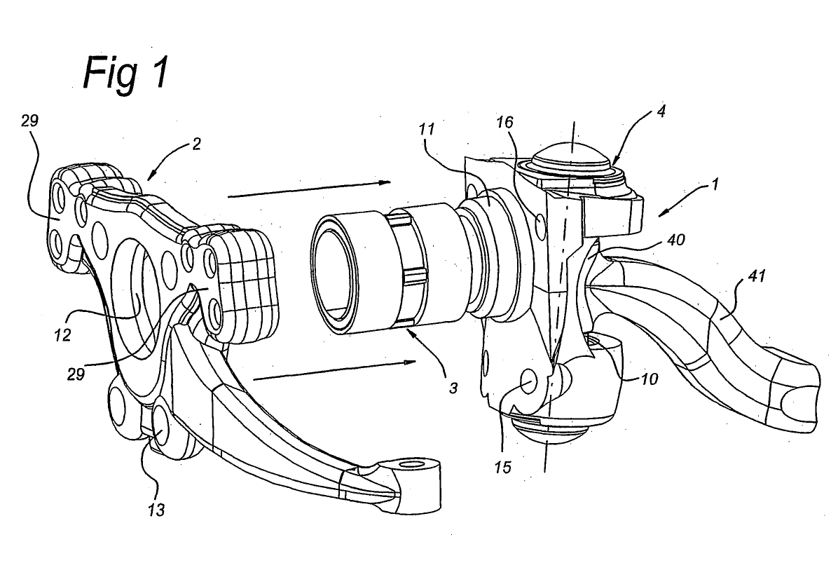

FIG. 1 shows a disassembled view of the truck corner module according to the invention.

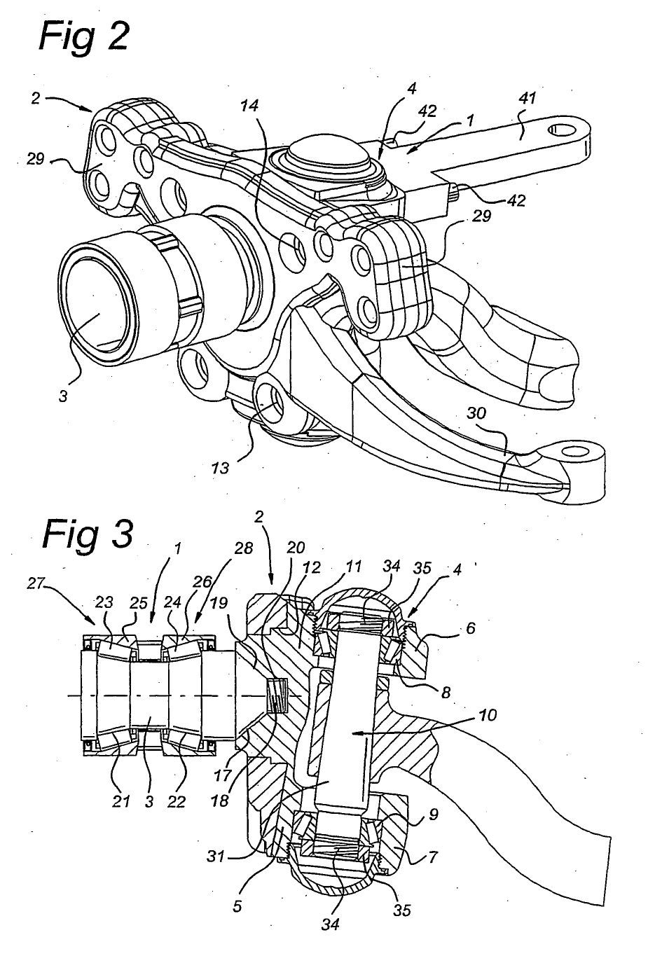

FIG. 2 shows an assembled view.

FIG. 3 shows a cross section through the truck corner module according to FIG. 2, including kingpin/housing connection with suspension beam.

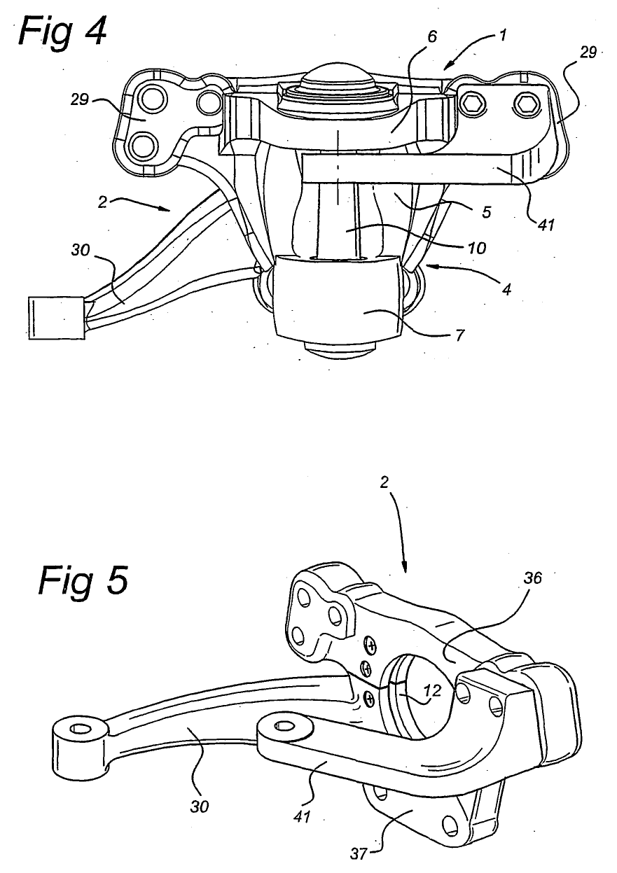

FIG. 4 shows a front view of the truck corner module.

FIG. 5 shows a split embodiment of the auxiliary unit.

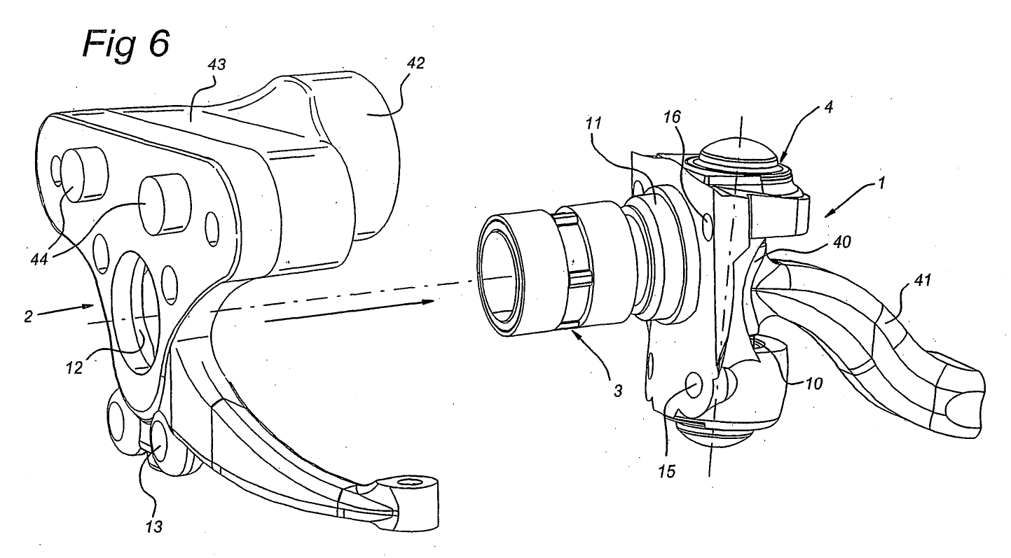

FIG. 6 shows a further embodiment.

The truck corner module as shown in the figures comprises a wheel carrying unit 1 and an auxiliary unit 2. The wheel carrying unit comprises an axle stub 3 as well as a kingpin arrangement 4. As shown in the cross section of FIG. 3, the kingpin arrangement comprises a base member 5, on one side of which the two coaxial support rings 6, 7 have been provided. These coaxial support rings carry the kingpin bearings 8, 9, by means of which the kingpin 10 is rotatably held. The kingpin 10 itself is connected to the truck wheel suspension. Said suspension comprises an axle shaft 41, having a bushing 40 in which the conically shaped part 31 of the kingpin 10 is fitted. By means of nuts 35 and kingpin threaded ends 34, the kingpin 10 is held with respect to the bearings 7, 8.

At the opposite side of the base member 5, the axle stub 3 projects. In the vicinity 5 of a joining area between the axles 3 and the base part 5, a mounting part 11 is provided which tightly fits in the bore 12 provided in the auxiliary unit 2. Thereby, a stable position of the auxiliary unit 2 with respect to the wheel carrying unit I is obtained.

By means of bolts (not shown), which are to be accommodated in the holes 13, 14 of the auxiliary unit 2, and in the screw threaded holes 15, 16 of the wheel carrying unit 1, these components can be firmly clamped together.

The axle stub can be carried out as a unity with the base part 5. However, in the embodiment shown the axle stub 3 is a separate component, which at its end facing towards the base part 5 has been provided with a cone shaped portion 17 as well as a screw threaded portion 18. The base part 5 also has a correspondingly cone shaped bore 19, which merges into the screw threaded bore 20.

By rotating the axle stub 3, the screw portions 20, 18 tightly draw the cone shaped portions 17, 19 together, thus ensuring a tight fit of the axle stub with respect to the base part 5. A securing means (not shown) can be applied for securing the axle stub 3 with respect to the base part 5.

The axle stub furthermore carries raceways 21, 22 which form part of the wheel bearings 27, 28 which furthermore comprise series of rollers 23, 24, and outer rings 25 respectively 26.

The auxiliary unit 2 according to FIGS. 1-5 is provided with an integral steering lever 30, as well as with integral mounting ears 29 for mounting a brake actuator. According to the embodiment of FIG. 5, the auxiliary unit 2 can consist of two halves 36, 37. The upper half 36 may comprise brake functions, the lower half 7, e.g. steer functions. This embodiment enables assembly in case the wheel flange is bigger than the center ring diameter in the knuckle.

Furthermore, a second, detachable steering lever 41 can be provided for power steering purposes, as shown in FIGS. 2, 4 and 5. This lever can be attached by means of bolts 42. In the embodiment of FIG. 4 and 5 the lever 41 is attached with the bolts (not shown) by means of which also the brake calliper is attached.

The embodiment of FIG. 6 shows the module in exploded view in analogy to the embodiment of FIG. 1. In this embodiment, the auxiliary unit 2 has been provided with two integrated mechanical actuators 44, only the actuating heads of which are visible. The mechanical actuators may for instance, in a known way, comprise walls through actuators.

Furthermore, the auxiliary unit 2 comprises an integrated motor 42, which may be of a hydraulic, pneumatic or electric type. The motor 42 powers the actuators 44 through a gear reduction mechanism 43, which is known per se and which has been integrated in the auxiliary unit 2 as well.

1-35. (cancelled)

36. Truck corner module, comprising a wheel carrying unit (1) provided with an axle stub (3) and a kingpin arrangement (4) as well as an auxiliary unit (2) mounted onto the wheel carrying unit (1), said auxiliary unit (2) being provided with at least parts (29; 42-44) for a brake means, characterized in that the axle stub (3) comprises a conically or cylindrically shaped end (17) at the narrow end of which a screw portion (18) is provided, and the kingpin arrangement comprises a correspondingly conically or cylindrically shaped bore (19) at the inner end of which a corresponding nut portion (20) is provided.

37. Module according to claim 36, wherein the axle stub is integrally formed with the kingpin arrangement.

38. Module according to claim 36 wherein the axle stub (3) and the kingpin arrangement (4) are connected to each other through mounting means (17, 19; 18, 20).

39. Module according to claim 38, wherein the mounting means comprise a screw threaded portions (18, 20).

40. Module according to claim 38, wherein the mounting means comprise a flange/bolt connection.

41. Module according to claim 38, wherein the mounting means comprise a centering/central bolt connection.

42. Module according to claim 38, wherein the mounting means comprise conically shaped portions (17, 19).

43. Module according to claim 38, wherein the mounting means comprise a cylindrical shaped portion.

44. Module according to claim 38, wherein the mounting means comprise a conical sleeve with sleeve thread on a cylindrical connection.

45. Module according to claim 38, wherein securing means are provided for securing the mounting means (17, 19; 18, 20).

46. Module according to claim 36, wherein the axle stub (3) is solid.

47. Module according to claim 36 wherein the axle stub has a throughgoing bore, e.g. for accommodating the drive shaft of a driven wheel.

48. Module according to claim 36, wherein the axle stub may consist of two or more permanently joint parts.

49. Module according to claim 36, wherein the axle stub (3) comprises two mutually spaced raceways (21, 22) for a wheel bearing means (27, 28).

50. Module according to claim 36, wherein the wheel bearing means (27, 28) comprises roller bearings, ball bearings or a combination thereof.

51. Module according to claim 36, wherein the wheel carrying unit (1) comprises a mounting part (11), and the auxiliary unit (2) comprises a mounting bore (12) mounted onto the mounting part (11), in such a way that the axle stub (3) projects at one side of the auxiliary unit (2), and the kingpin arrangement (4) at the other side of the auxiliary unit (2).

52. Module according to claim 51, wherein the wheel carrying unit (1) and the auxiliary unit (2) are bolted together.

53. Module according to claim 36, wherein the auxiliary unit (2) carries a steering device, e.g. a lever (30).

54. Module according to claim 36, wherein the auxiliary unit (2) comprises two fixation ears (29) for a brake, said fixation ears (29) being positioned on opposite sides of a plane defined by the axle stub axis.

55. Module according to claim 36, where the auxiliary unit (2) carries a hydraulic, pneumatic, electric-mechanical brake or a combination thereof.

56. Module according to claim 36, wherein the wheel carrying unit (1) comprises a base member (5) which carries two coaxial support rings (6, 7) for accommodating kingpin support bearings (8, 9).

57. Module according to claim 56, wherein the bearings comprise a roller bearing, ball bearing and/or a plain bearing.

58. Module according to claim 56, wherein the base member (5) carries the axle stub (3), said axle stub (3) facing away from the support rings (6, 7).

59. Module according to claim 56, wherein the auxiliary unit is made of a metallic, non-metallic or composite material or obtained by powder metal techniques.

60. Module according to claim 56, wherein the wheel carrying unit is made of a metallic, non-metallic or composite material or obtained by powder metal techniques.

61. Module according claim 36, wherein the module incorporates sensors for controlling bearing speed, bearings load, angular displacement, temperature, ABS brake system etc.

62. Module according to claim 36, wherein the kingpin arrangement (4) comprises a kingpin (10) having fixation means (40) for a suspension bearing (41).

63. Module according to claim 36, wherein a power steering lever (41) is connected to the axle stub and kingpin arrangement.

64. Module according to claim 36, wherein the auxiliary unit (2) is provided with fixation means (29) for mounting a brake means.

65. Module according to claim 36, wherein the auxiliary unit (2) is provided with at least one integrated actuator (44) for a brake means.

66. Module according to claim 65, wherein the auxiliary unit (2) is provided with a motor means for powering the at least one actuator (44).

67. Module according to claim 66, wherein the motor means (42) is of a pneumatic or a hydraulic type.

68. Module according to claim 66, wherein the motor means (42) comprises an electric motor.

69. Module according to claim 65, wherein the auxiliary unit (2) comprises gear reduction means (43).
